(19) United States
(12) Patent Application Publication
(10) Pub. No.: US 2009/0263588 A1
(43) Pub. Date: Oct. 22, 2009

(54) PHOTOCURABLE COATING COMPOSITION, AND OVERPRINT AND PROCESS FOR PRODUCING SAME

(75) Inventor: Ryuki Kakino, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/423,986

(22) Filed: Apr. 15, 2009

(30) Foreign Application Priority Data
Apr. 21, 2008 (JP) 2008-110364

(51) Int. Cl. C08F 2/46; C08J 3/28

(52) U.S. Cl. 427/487; 522/113

(57) ABSTRACT

A photocurable coating composition is provided that includes (A) a fluorine-containing polymer having a cationically polymerizable group, (B) a cationic photopolymerization initiator, and (C) a cationically polymerizable compound. There is also provided a process for producing an overprint, the process including a step of coating a printed material with a photocurable composition and a step of photocuring the photocurable composition to form an overprint layer, the photocurable composition including (A) a fluorine-containing polymer having a cationically polymerizable group, (B) a cationic photopolymerization initiator, and (C) a cationically polymerizable compound.

### BACKGROUND OF THE INVENTION

1. Field of the Invention

The present invention relates to a photocurable coating composition, and to an overprint and a process for producing same.

2. Description of the Related Art

In recent years, photocurable compositions, in particular UV curable compositions, have been used in a large number of applications. Examples thereof include printing inks, overcoat varnishes, paints, adhesives, and photoresists.

In particular, a printed material in which an overprint coating is applied on top of toner-based image information such as in an electrophotographic method so as to improve protection of a printed material and give surface gloss has been commercialized as an alternative product to a silver halide photographic print and is attracting attention.

In a standard method for forming a toner-based image, such as an electrophotographic process, an electrostatic charge is formed on a latent image retaining surface by uniformly charging a latent image retaining surface such as, for example, a photoreceptor. Subsequently, charge on the uniformly charged region is selectively released by a pattern of activation irradiation corresponding to an original image. The latent image charge pattern remaining on the surface corresponds to regions that have not been exposed to radiation. Subsequently, the photoreceptor is passed through one or a plurality of development housings containing toner, and since the toner is deposited on the charge pattern by electrostatic attractive force, the latent image charge pattern is visualized. Subsequently, the developed image is either fixed on an image-forming surface or transferred to a printing substrate such as, for example, paper and fixed thereto by an appropriate fixation technique, thus giving an electrophotographically printed material, that is, a toner-based printed material.

As a known method for protecting a printed material, applying an overprint coating to the printed material has been proposed. For example, Patent Document JP-A-11-706471 (JP-A denotes a Japanese unexamined patent application publication) and JP-A-2003-241414 propose a method such as an electrophotographic process, in which fixation is carried out after a transparent toner is transferred on top of a toner-based image, thus covering the surface.

Furthermore, Patent Document 3 proposes a method in which an overprint coating is applied by applying a liquid film coating that is curable by UV rays, etc. and polymerizing (crosslinking) a coating component by means of light.

Furthermore, Patent Document 4 discloses an overprint composition comprising a radiation curable oligomer selected from the group consisting of trifunctional unsaturated acrylic resins, a radiation curable monomer selected from the group consisting of polyfunctional alkoxylated acrylic monomers and polyalkoxylated acrylic monomers, such as one type or a plurality of types of diacrylate or triacrylate, at least one type of photopolymerization initiator, and at least one type of surfactant.

Furthermore, JP-A-7-33811 discloses a photoinitiator obtained by an esterification reaction of a carboxylic acid-containing addition-polymerization polymer having a weight-average molecular weight of at least 5,000 and a hydroxy group-containing phenyl ketone compound.

Moreover, JP-A-2-270844 discloses a copolymerizable phenone derivative.

Furthermore, JP-A-2006-334925 discloses an image formation method that employs a recording head for discharging onto a recording medium at least one type of ink containing as a photocurable component a cationically curable monomer, and a light irradiation device for irradiating the ink that has landed on the recording medium with light so as to cure the ink, the total amount of ink cured by irradiating once with light being less than 10.0 g/m², and the ink containing a compound having deodorizing ability.

### BRIEF SUMMARY OF THE INVENTION

It is an object of the present invention to provide a photocurable coating composition giving excellent surface smoothness, non-tackiness (suppression of surface tackiness), and suppression of odor, an overprint obtained by using the photocurable coating composition, and a process for producing same.

The above object has been attained by means described in [1] or [9]. They are described below together with [2] to [8] and [10] to [19], which are preferred embodiments.

[1] A photocurable composition comprising (A) a fluorine-containing polymer having a cationically polymerizable group, (B) a cationic photopolymerization initiator, and (C) a cationically polymerizable compound,
[2] the photocurable composition according to [1], wherein the cationically polymerizable group of the fluorine-containing polymer (A) having a cationically polymerizable group is at least one group selected from the group consisting of an epoxy group, an oxetanyl group, and a vinyloxy group,
[3] the photocurable composition according to [1] or [2], wherein the cationically polymerizable group of the fluorine-containing polymer (A) having a cationically polymerizable group is an epoxy group and/or an oxetanyl group,
[4] the photocurable composition according to any one of [1] to [3], wherein the fluorine-containing polymer (A) having a cationically polymerizable group comprises at least a monomer unit having a cationically polymerizable group and a monomer unit represented by Formula (1) below

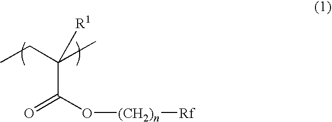

(in Formula (1), R¹ denotes a hydrogen atom or a methyl group, Rf denotes a fluoroalkyl group- or perfluoroalkyl group-containing group containing 4 or more fluorine atoms, and n denotes 1 or 2),
[5] the photocurable composition according to [4], wherein the fluorine-containing polymer (A) having a cationically polymerizable group comprises, of the total monomer units, 1 to 60 mol % of a monomer unit represented by Formula (1),
[6] the photocurable composition according to any one of [1] to [5], wherein the fluorine-containing polymer (A) having a cationically polymerizable group has a weight-average molecular weight of at least 1,000 but no greater than 100,000,
[7] the photocurable composition according to any one of [1] to [6], wherein it has substantially no absorption in the visible region,
[8] the photocurable composition according to any one of [1] to [7], wherein the fluorine-containing polymer (A) having a cationically polymerizable group has a content of 0.001 to 40 wt % of the entire photocurable composition,
[9] a process for producing an overprint, the process comprising a step of coating a printed material with a photocurable composition and a step of photocuring the photocurable composition to form an overprint layer, the photocurable composition comprising (A) a fluorine-containing polymer having a cationically polymerizable group, (B) a cationic photopolymerization initiator, and (C) a cationically polymerizable compound,
[10] the process for producing an overprint according to [9], wherein the cationically polymerizable group of the fluorine-containing polymer (A) having a cationically polymerizable group is at least one group selected from the group consisting of an epoxy group, an oxetanyl group, and a vinyloxy group,
[11] the process for producing an overprint according to [9] or [10], wherein the cationically polymerizable group of the fluorine-containing polymer (A) having a cationically polymerizable group is an epoxy group and/or an oxetanyl group,
[12] the process for producing an overprint according to any one of [9] to [11], wherein the fluorine-containing polymer (A) having a cationically polymerizable group comprises at least a monomer unit having a cationically polymerizable group and a monomer unit represented by Formula (1) below

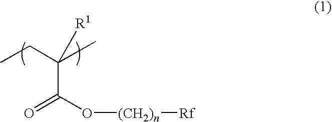

(in Formula (1), R¹ denotes a hydrogen atom or a methyl group, Rf denotes a fluoroalkyl group- or perfluoroalkyl group-containing group containing 4 or more fluorine atoms, and n denotes 1 or 2),
[13] the process for producing an overprint according to [12], wherein the fluorine-containing polymer (A) having a cationically polymerizable group comprises, of the total monomer units, 1 to 60 mol % of a monomer unit represented by Formula (1),
[14] the process for producing an overprint according to any one of [9] to [13], wherein the fluorine-containing polymer (A) having a cationically polymerizable group has a content of 0.001 to 40 wt % of the entire photocurable composition,
[15] the process for producing an overprint according to any one of [9] to [14], wherein the printed material is an electrophotographically printed material,
[16] the process for producing an overprint according to any one of [9] to [15], wherein the printed material is an electrophotographically printed material having a fuser oil layer,
[17] the process for producing an overprint according to any one of [9] to [16], wherein the overprint layer has a thickness of at least 1 μm but no greater than 10 μm,
[18] the process for producing an overprint according to any one of [9] to [17], wherein the overprint layer is formed in an amount of 1 to 10 g/m², and
[19] the process for producing an overprint according to any one of [9] to [18], wherein the overprint layer has substantially no absorption in the visible region.

### DETAILED DESCRIPTION OF THE INVENTION

The present invention is explained in detail below.

### Photocurable Composition

The photocurable composition of the present invention (hereinafter, also called a ‘photocurable coating composition’ or a ‘coating composition’) comprises (A) a fluorine-containing polymer having a cationically polymerizable group, (B) a cationic photopolymerization initiator, and (C) a cationically polymerizable compound.

The overprint of the present invention comprises an overprint layer formed by photocuring the photocurable coating composition above a printed material.

The process for producing an overprint of the present invention comprises a step of coating a printed material with the photocurable coating composition and a step of photocuring the coating composition.

Furthermore, the printed material is preferably an electrophotographically printed material.

The photocurable coating composition of the present invention is curable upon exposure to actinic radiation such as an electron beam or UV rays. In particular, it can be used as a photocurable coating composition for coating an image formed by depositing ink and/or toner on a printing substrate (image receiving substrate) by a method such as lithography, relief printing, intaglio printing, screen printing, inkjet, or electrophotography. More particularly, the photocurable coating composition of the present invention is particularly suitable for a photocurable overprint composition (overprint composition) for coating a toner-based printed material printed by an electrophotographic process.

The photocurable coating composition of the present invention preferably has substantially no absorption in the visible region. ‘Having substantially no absorption in the visible region’ means either having no absorption in a visible region of 400 to 700 nm or having only a level of absorption in the visible region that does not cause any problem as a photocurable coating composition. Specifically, a 5 μm optical path length transmittance of the coating composition in a wavelength region of 400 to 700 nm is at least 70%, and preferably at least 80%.

The photocurable coating composition of the present invention may suitably be used as one for an overprint, and may particularly suitably be used as one for an overprint for an electrophotographically printed material.

When the photocurable coating composition of the present invention is used for forming an overprint layer on an electrophotographically printed material having an image area with a thickness of a toner, an overprint with excellent non-tackiness and surface smoothness and having luster and gloss can be obtained, and an impression that it is visually close to a conventional silver halide photographic print can be given.

When a fuser oil layer is present on an image surface in a toner-based image such as in an electrophotographic method, since the surface of a printed material is hydrophobic and the surface energy is low, it is currently difficult to obtain a photocurable composition that satisfies all of curability, surface smoothness, strength, storage stability, etc.

However, even for a toner image with a fuser oil layer on the image surface, the photocurable coating composition of the present invention can give an overprint that gives an image-printed material that is excellent in non-tackiness and surface smoothness, has luster and gloss, little distortion, and high flexibility, and that is visually close to a silver halide photographic print.

Furthermore, with regard to a toner-based image such as in an electrophotographic method, when a fuser oil layer is present on an image surface, since the surface of a printed material is hydrophobic and the surface energy is low, it is currently difficult to obtain a photocurable composition that satisfies all of curability, surface smoothness, strength, storage stability, etc.

In particular, when an overprint coating is applied onto toner-based image information to thus serve as an alternative product to a silver halide photographic print, since a consumer handles it directly, product safety and odor are counted as important product qualities.

As a cause of the occurrence of an odor, there can be cited a residual volatile compound such as a polymerizable monomer (uncured monomer), a decomposition product of a polymerization initiator that is not incorporated into a cured coating due to lack of copolymerizability with a curable composition, etc.

With regard to suppression of odor due to the polymerizable monomer, from the viewpoint of low volatility, use of a solid monomer or a high molecular weight liquid monomer can be considered, but since the viscosity of the polymerizable composition increases, the surface smoothness deteriorates, thus causing the problem of lines, etc. occurring on the surface of a printed material.

By comprising a fluorine-containing polymer having a cationically polymerizable group, the photocurable coating composition of the present invention gives excellent surface smoothness and non-tackiness (suppression of surface tackiness) and can suppress odor in an overprint.

### (A) Fluorine-Containing Polymer Having Cationically Polymerizable Group

The photocurable coating composition of the present invention comprises at least a fluorine-containing polymer having a cationically polymerizable group (hereinafter, also called simply a ‘specific fluorine polymer’).

The fluorine-containing polymer having a cationically polymerizable group that can be used in the present invention is a polymer that has at least one cationically polymerizable group and contains a fluorine atom, and there are no particular restrictions other than the above.

Preferred examples of the cationically polymerizable group include a cyclic ether group and a vinyloxy group.

As the cyclic ether group, there can be cited an epoxy group (including an alicyclic epoxy group, the same applies below), an oxetanyl group, an oxolanyl group, etc.

Among the cyclic ether groups, a cyclic ether group having 2 to 6 carbon atoms is preferable, and a cyclic ether group having 2 or 3 carbon atoms (an epoxy group or oxetanyl group) is more preferable. Furthermore, the cyclic ether group may be monocyclic or polycyclic.

Specifically, the cyclic ether group is particularly preferably a cyclic ether group shown below. Among them, an epoxy group and an oxetanyl group are particularly preferable.

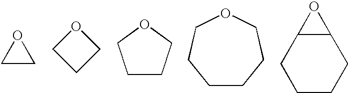

A carbon atom forming the cyclic ether group may have a substituent introduced thereinto. Examples of substituents that can be introduced include an alkyl group having 1 to 18 carbon atoms, a cycloalkyl group having 3 to 12 carbon atoms, an aryl group having 6 to 14 carbon atoms, an alkoxy group having 1 to 18 carbon atoms, an aryloxy group having 6 to 10 carbon atoms, an alkylamino group having 1 to 18 carbon atoms, and an arylamino group having 6 to 10 carbon atoms.

Furthermore, as a preferred cationically polymerizable group other than a cyclic ether group, a vinyloxy group can be cited. A carbon atom forming the vinyloxy group may have a substituent introduced thereinto. Examples of substituents that can be introduced include an alkyl group having 1 to 18 carbon atoms, a cycloalkyl group having 3 to 12 carbon atoms, an aryl group having 6 to 14 carbon atoms, an alkoxy group having 1 to 18 carbon atoms, an aryloxy group having 6 to 10 carbon atoms, an alkylamino group having 1 to 18 carbon atoms, and an arylamino group having 6 to 10 carbon atoms.

Moreover, the amount of cationically polymerizable group introduced into the specific fluorine polymer is preferably in the range of 0.1 to 100 mmol/g, and more preferably 0.2 to 80 mmol/g. When the amount of cationically polymerizable group introduced into the specific fluorine polymer is at least 0.1 mmol/g, the ability to suppress surface tackiness is excellent, and when the amount introduced is no greater than 100 mmol/g, storage stability is excellent.

Preferred examples of the cationically polymerizable group include an epoxy group, an oxetanyl group, and/or a vinyloxy group, and more preferred examples thereof include an epoxy group and/or an oxetanyl group.

With regard to the cationically polymerizable group in the specific fluorine polymer, there may be one type on its own or two or more types.

Furthermore, in the coating composition of the present invention, with regard to the specific fluorine polymer, one type thereof may be used on its own or two or more types thereof may be used.

The specific fluorine polymer that can be used in the present invention is preferably an addition-polymerized resin obtained by addition polymerization, and more preferably a radically polymerized resin obtained by radical polymerization.

Furthermore, the specific fluorine polymer is preferably a copolymer of a monomer having a fluorine atom-containing group and a monomer having a cationically polymerizable group or a monomer having a group into which a cationically polymerizable group can be introduced.

Examples of the group into which a cationically polymerizable group can be introduced include a reactive group such as a hydroxy group or an amino group to which a cationically polymerizable group-containing group can be separately bonded.

The specific fluorine polymer preferably comprises at least a monomer unit having a cationically polymerizable group and a monomer unit represented by Formula (1) below.

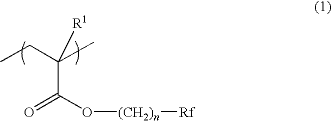

(In Formula (1), R¹ denotes a hydrogen atom or a methyl group, Rf denotes a fluoroalkyl group- or perfluoroalkyl group-containing group having 4 or more fluorine atoms, and n denotes 1 or 2.)

Here, with regard to the fluoroalkyl group or perfluoroalkyl group denoted by Rf, use of one with 4 or more fluorine atoms enables the surface energy of the photocurable coating composition to be significantly lowered, thus contributing greatly to an improvement in surface smoothness. In particular, one with 4 to 30 fluorine atoms per monomer unit is preferable, and one with 9 to 25 is more preferable. When in this range, the specific fluorine polymer gives excellent surface smoothness. Furthermore, it is preferable for the number of fluorine atoms per monomer unit to be no greater than 30 since degradation of solubility due to the oil repellency of fluorine atoms is avoided.

The monomer unit represented by Formula (1) is preferably a monomer unit represented by Formula (1-2) or Formula (1-3) below.

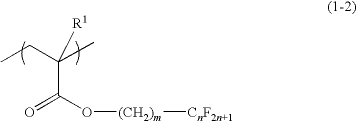

In Formula (1-2), R¹ denotes a hydrogen atom or a methyl group, m denotes 1 or 2, and n denotes an integer of 2 to 12.

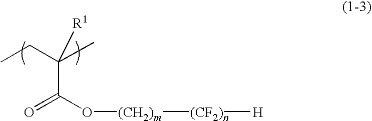

In Formula (1-3), R¹ denotes a hydrogen atom or a methyl group, m denotes 1 or 2, and n denotes an integer of 2 to 12.

Furthermore, the specific fluorine polymer preferably comprises, of the total monomer units, a fluorine atom-containing monomer unit in the range of 1 to 60 mol %, more preferably in the range of 3 to 50 mol %, and yet more preferably in the range of 5 to 40 mol %. When the content of the fluorine atom-containing monomer unit is at least 1 mol %, a desired surface smoothness can be obtained. When the content of the fluorine atom-containing monomer unit is no greater than 60 mol %, the solubility of the specific fluorine polymer is sufficient.

The fluorine atom-containing monomer that is used in production of the specific fluorine polymer is not particularly limited, but is preferably a fluorine atom-containing (meth)acrylate compound and/or a fluorine atom-containing (meth)acrylamide compound, and more preferably a fluorine atom-containing (meth)acrylate compound.

Furthermore, the fluorine atom-containing monomer that is used in production of the specific fluorine polymer is preferably a monomer represented by Formula (1-1) below.

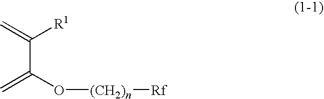

R¹, Rf, and n in Formula (1-1) have the same meanings of those of R¹, Rf, and n in Formula (1) above, and preferred ranges are also the same.

The specific fluorine polymer is preferably a polymer comprising at least a fluorine atom-containing monomer unit and a monomer unit having a cationically polymerizable group, more preferably a polymer comprising at least a monomer unit represented by Formula (1) above and a monomer unit represented by Formula (2) below, and yet more preferably a polymer comprising only a monomer unit represented by Formula (1) above and a monomer unit represented by Formula (2) below.

The specific fluorine polymer may comprise one type of the monomer unit having a cationically polymerizable group on its own or two or more types thereof, and the fluorine atom-containing monomer unit may further have a cationically polymerizable group.

The monomer unit having a cationically polymerizable group is preferably a monomer unit represented by Formula (2) below.

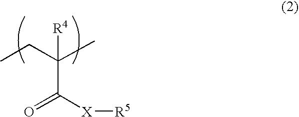

(In Formula (2), R⁴ denotes a hydrogen atom or a methyl group, X denotes O or NR, R denotes a hydrogen atom or a monovalent organic group, and R⁵ denotes a group having a cationically polymerizable group.)

R⁵ in Formula (2) denotes a group having at least one cationically polymerizable group. The number of cationically polymerizable groups in R⁵ is preferably one or two, and more preferably one.

Furthermore, the cationically polymerizable group may be present at any position of R⁵, but is preferably present at the terminal of R⁵.

The cationically polymerizable group in Formula (2) has the same meaning as that of the above-mentioned cationically polymerizable group, and a preferred range is also the same.

With regard to R⁵ in Formula (2), the cationically polymerizable group and X may be bonded via a polyvalent linking group, that is, a di- or higher-valent linking group.

As the polyvalent linking group, there can be cited the partial structures below or a linking group formed by combination of two or more of the partial structures below.

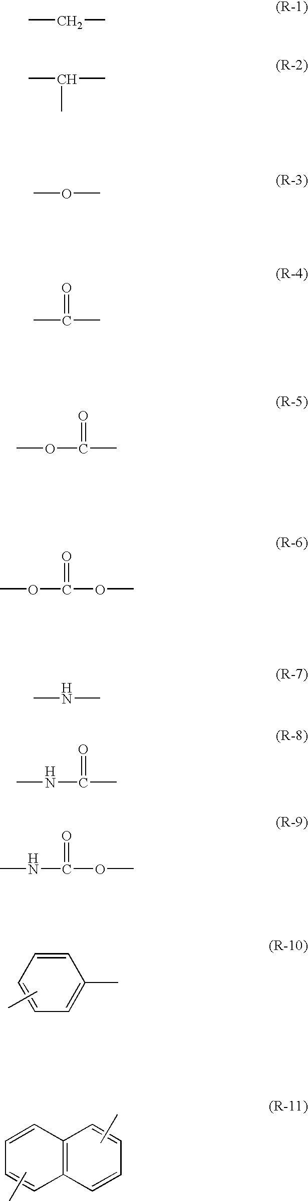

R⁵ in Formula (2) may further have a substituent.

Examples of the substituent include an alkoxy group having 1 to 4 carbon atoms, a halogen atom (a fluorine atom, a chlorine atom, a bromine atom, an iodine atom), an acyl group, an acyloxy group, a cyano group, a hydroxy group, a carboxy group, an alkoxycarbonyl group, and a nitro group.

Furthermore, R in Formula (2) denotes a hydrogen atom or a monovalent organic group.

The monovalent organic group is not particularly limited, but is preferably a hydrocarbon group or a group having a cationically polymerizable group in R⁵.

The above R is preferably a hydrogen atom, an alkyl group, or a group having the above cationically polymerizable group, and is more preferably a hydrogen atom.

Specific preferred examples of the monomer unit having a cationically polymerizable group include those listed below, but it is not limited thereto.

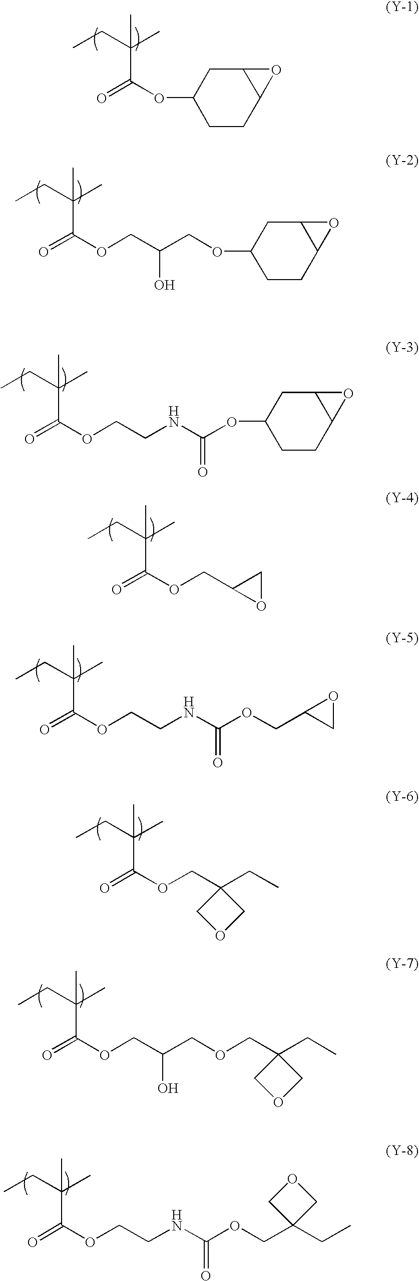

The monomer having a cationically polymerizable group or a group into which a cationically polymerizable group can be introduced, which is used in production of the specific fluorine polymer, is not particularly limited, and is preferably a (meth)acrylate compound and/or a (meth)acrylamide compound and more preferably a (meth)acrylate compound.

The specific fluorine polymer may comprise another monomer unit other than the fluorine atom-containing monomer unit and the monomer unit having a cationically polymerizable group.

The other monomer unit may be any monomer unit formed from a known monomer, and is preferably a monomer unit formed from a known radically polymerizable monomer and more preferably a monomer unit formed from a (meth)acrylate compound and/or a (meth)acrylamide compound.

The monomer that can be used in production of the specific fluorine polymer is not particularly limited, and is preferably a radically polymerizable monomer and more preferably a monomer having an ethylenically unsaturated bond.

With regard to the radically polymerizable monomer, specific examples thereof include radically polymerizable compounds, for example, unsaturated carboxylic acids such as acrylic acid, methacrylic acid, itaconic acid, crotonic acid, isocrotonic acid, and maleic acid, and salts thereof, anhydrides having an ethylenically unsaturated group, acrylonitrile, styrene, and various unsaturated polyesters, unsaturated polyethers, unsaturated polyamides, and unsaturated urethanes.

Specific examples thereof include acrylic acid derivatives such as methyl acrylate, ethyl acrylate, n-butyl acrylate, 2-ethylhexyl acrylate, 2-hydroxyethyl acrylate, butoxyethyl acrylate, carbitol acrylate, cyclohexyl acrylate, tetrahydrofurfuryl acrylate, benzyl acrylate, N-methylolacrylamide, diacetoneacrylamide, and epoxyacrylate, methacrylic derivatives such as methyl methacrylate, n-butyl methacrylate, 2-ethylhexyl methacrylate, lauryl methacrylate, allyl methacrylate, glycidyl methacrylate, benzyl methacrylate, and dimethylaminomethyl methacrylate, N-vinyl compounds such as N-vinylpyrrolidone and N-vinylcaprolactam, allyl compound derivatives such as allyl glycidyl ether, diallyl phthalate, and triallyl trimellitate and, more specifically, radically polymerizable or crosslinking monomers, oligomers, and polymers that are commercial products or are industrially known, such as those described in ‘Kakyozai Handobukku’ (Crosslinking Agent Handbook), Ed. S. Yamashita (Taiseisha, 1981); ‘UV•EB Koka Handobukku’ (UV•EB Curing Handbook) (Starting Materials) Ed. K. Kato (Kobunshi Kankoukai, 1985); ‘UV•EB Koka Gijutsu no Oyo to Shijyo’ (Application and Market of UV•EB Curing Technology), p. 79, Ed. Rad Tech (CMC, 1989); and E. Takiyama ‘Poriesuteru Jushi Handobukku’ (Polyester Resin Handbook), (The Nikkan Kogyo Shimbun Ltd., 1988) may be used.

Furthermore, the specific fluorine polymer is preferably a polymer represented by Formula (3) below.

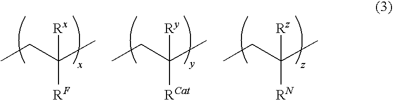

(In Formula (3), R^{F} denotes a group having 4 or more fluorine atoms, R^{Cat} denotes a group having a cationically polymerizable group, R^{N} denotes an organic group that does not contain a fluorine atom or a cationically polymerizable group, R^{x}, R^{y}, and R^{z} independently denote a hydrogen atom or a methyl group, x denotes 1 to 60, y denotes 20 to 99, z denotes 0 to 79, and x+y+z=100.)

R^{F} in Formula (3) denotes a group containing 4 or more fluorine atoms, and is preferably a fluoroalkyl group and/or perfluoroalkyl group containing 4 or more fluorine atoms.

R^{cat} in Formula (3) denotes a group having a cationically polymerizable group, and is preferably —COOR^{D} or —CONHR^{D}. Said R^{D} denotes a group having at least one cationically polymerizable group, preferably a group having 1 or 2 cationically polymerizable groups, and more preferably a group having one cationically polymerizable group.

R^{N} in Formula (3) denotes an organic group that does not contain a fluorine atom or a cationically polymerizable group, and is preferably —COOR^{E} or —CONHR^{E}. Said R^{E} denotes a monovalent organic group, preferably a hydrocarbon group having 1 to 20 carbons, and more preferably a methyl group.

x, y, and z in Formula (3) denote the molar proportions of the monomer units, and x+y+z=100.

x in Formula (3) denotes 1 to 60, preferably 3 to 50, and more preferably 5 to 40.

y in Formula (3) denotes 20 to 99, and preferably 30 to 97.

z in Formula (3) denotes 0 to 79, preferably 0 to 20, and more preferably 0.

With regard to each of the monomer units in Formula (3), there may be one type on its own, or there may be two or more types.

Although depending on a quenching method, etc. of a polymerization reaction, examples of the terminus of the polymer represented by Formula (3) include a hydrogen atom, a hydroxy group, and an unsaturated double bond, and a hydrogen atom is preferable.

Specific examples of the specific fluorine polymer that can suitably be used in the present invention are listed below, but the present invention is not limited thereto.

In the present invention, a hydrocarbon chain in a chemical formula is sometimes represented by a simplified structural formula in which symbols for carbon (C) and hydrogen (H) are omitted.

In the specific examples below, figures appended to the brackets of each monomer unit denote the molar proportion of each monomer unit in the polymer, and 100 means that it is a homopolymer comprising said monomer unit alone.

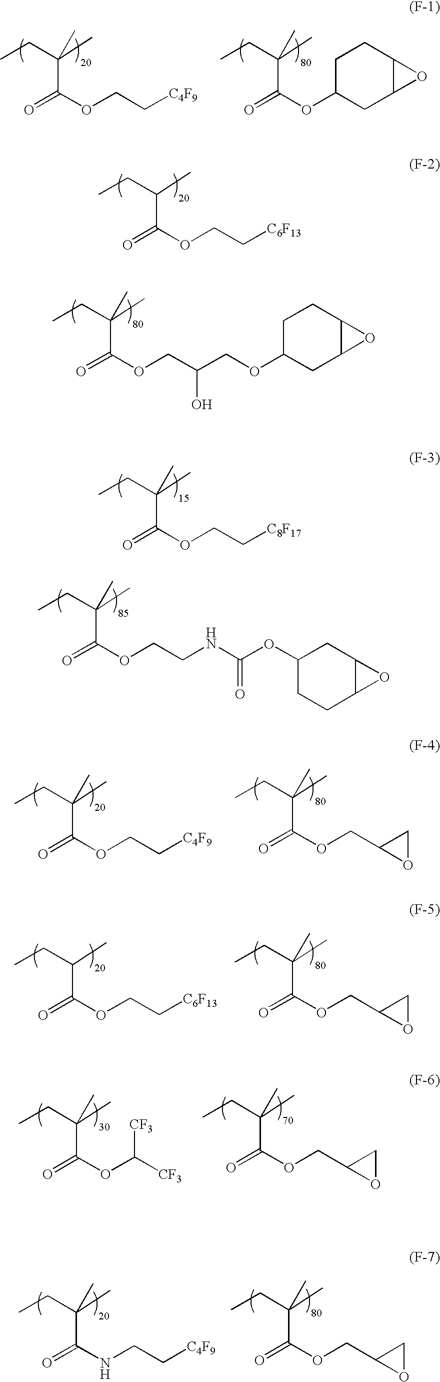

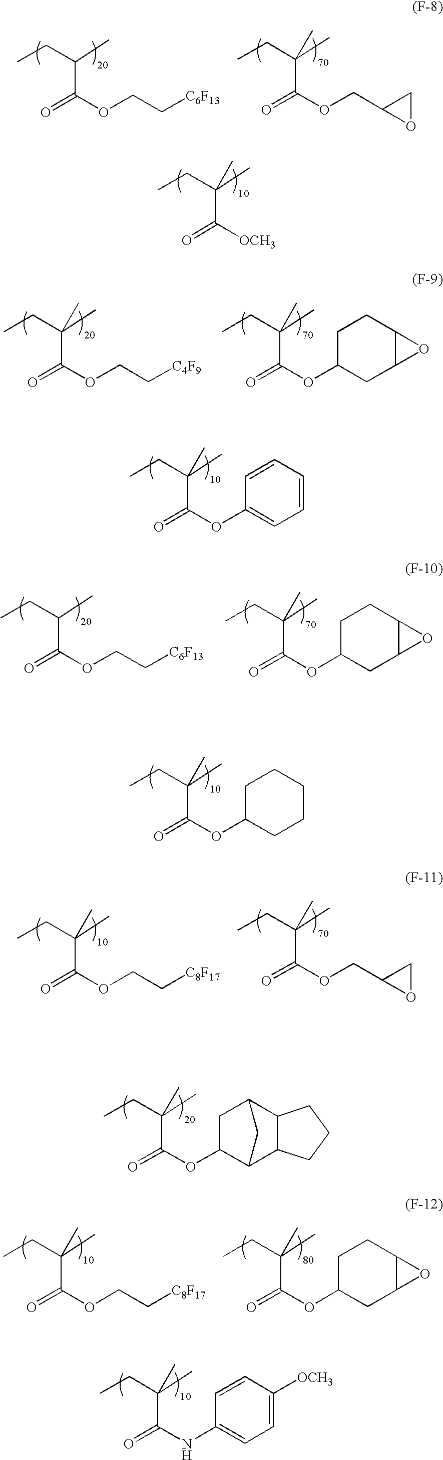

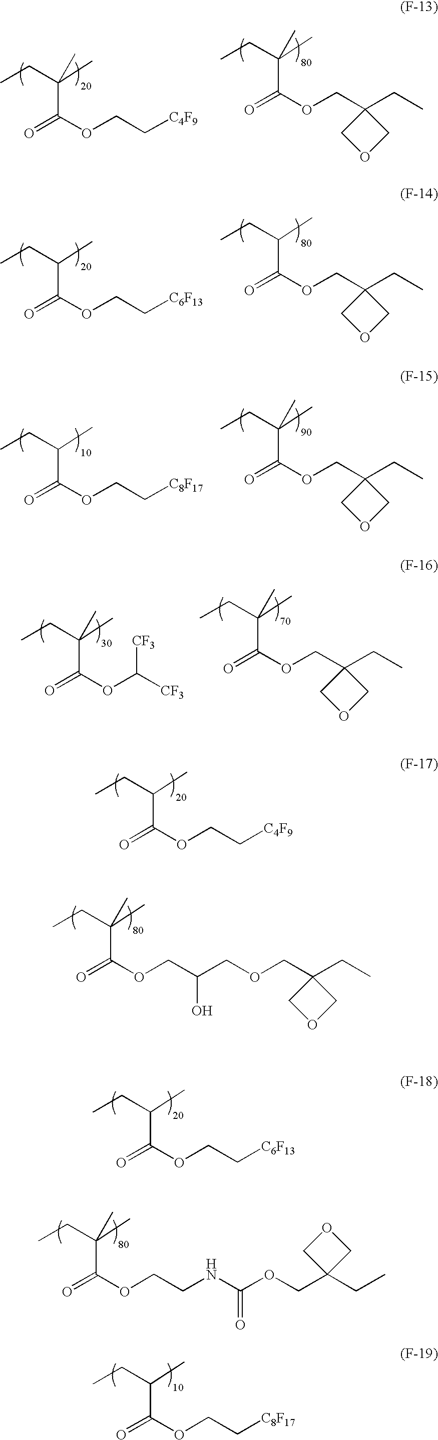

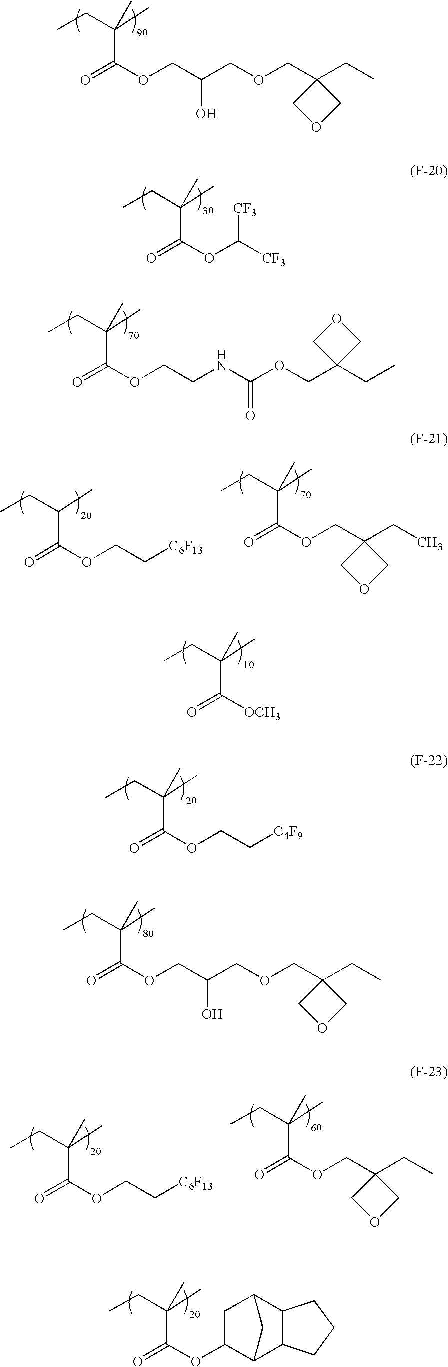

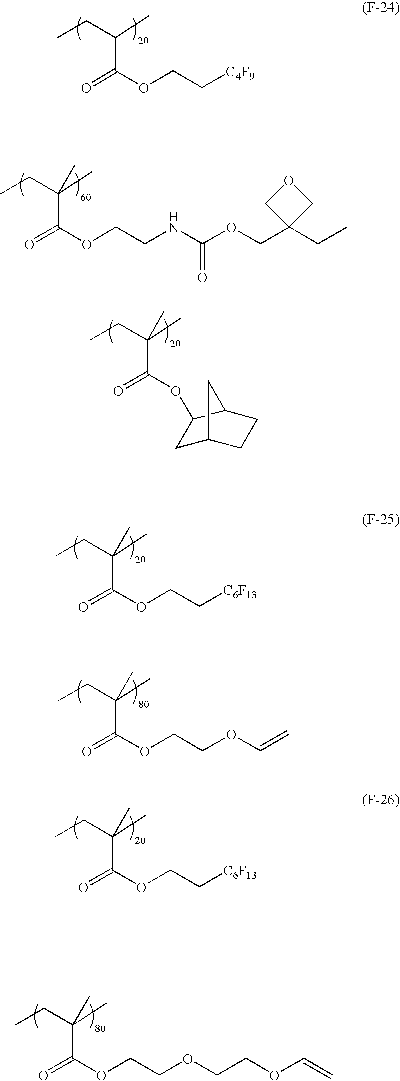

The weight-average molecular weight of the specific fluorine polymer is preferably 1,000 to 100,000, more preferably 3,000 to 70,000, and yet more preferably 4,000 to 40,000. When the weight-average molecular weight is at least 1,000, the properties of a surface coating are excellent, thus giving excellent non-tackiness. Furthermore, when the weight-average molecular weight is no greater than 100,000, the solubility in a coating composition is excellent.

From the viewpoint of surface tackiness suppression (non-tackiness) and surface smoothness, the content of the specific fluorine polymer in the photocurable coating composition of the present invention, relative to the total weight of the photocurable coating composition, is preferably in the range of 0.001 to 40 wt %, more preferably in the range of 0.01 to 30 wt %, yet more preferably in the range of 0.1 to 20 wt %, and particularly preferably in the range of 0.5 to 5 wt %.

### (B) Cationic Photopolymerization Initiator

The coating composition of the present invention comprises (B) a cationic photopolymerization initiator.

As the cationic photopolymerization initiator, a known cationic photopolymerization initiator may be used.

The cationic photopolymerization initiator used in the coating composition of the present invention is a compound that absorbs external energy from actinic radiation and generates a cationic polymerization initiating species. Examples of the actinic radiation include γ-rays, β-rays, an electron beam, UV rays, visible light, and IR rays. The wavelength used is not particularly limited, but is preferably a wavelength range of 200 to 500 nm, and more preferably 200 to 450 nm.

The content of the cationic photopolymerization initiator in the present invention, relative to the total amount of the cationically polymerizable compound is preferably 0.01 to 35 wt %, more preferably 0.1 to 30 wt %, and yet more preferably 0.5 to 30 wt %.

Furthermore, when a sensitizer, which will be described later, is used, the ratio by weight of the cationic photopolymerization initiator to the sensitizer (cationic photopolymerization initiator:sensitizer) is preferably 200:1 to 1:200, more preferably 50:1 to 1:50, and yet more preferably 20:1 to 1:5.

In the present invention, as a cationic polymerization initiator (photo-acid generator) that is used in combination with a cationically polymerizable compound, for example, compounds that are used for chemically amplified photoresists or cationic photopolymerization are used (e.g. ‘Imejingu you Yukizairyou’ (Organic Materials for Imaging), Ed. The Japanese Research Association for Organic Electronics Materials, Bunshin Publishing Co. (1993), pp. 187-192).

Examples of cationic polymerization initiators that are suitable in the present invention are as follows.

That is, firstly, there can be cited an onium compound such as diazonium, ammonium, iodinium, sulfonium, phosphonium, etc. These onium compounds are preferably aromatic onium compounds. The counter anion is not limited but B(C₆F₅)₄⁻, PF₆⁻, AsF₆⁻, SbF₆⁻ and CF₃SO₃⁻ are particularly preferable. Secondly, there can be cited sulfonated materials that generate a sulfonic acid. Thirdly, halides that photogenerate a hydrogen halide can also be used. Fourthly, iron arene complexes can be used.

With regard to the above-mentioned cationic photopolymerization initiator, one type thereof may be used on its own or two or more types may be used in combination.

### (C) Cationically Polymerizable Compound

The coating composition of the present invention comprises (C) a cationically polymerizable compound.

The cationically polymerizable compound in the present invention is not particularly limited as long as it is a compound that undergoes a cationic polymerization reaction by the application of some type of energy and cures; any type of monomer, oligomer, or polymer may be used and, in particular, various types of known cationically polymerizable monomers, known as cationically photopolymerizable monomers, that undergo a polymerization reaction by an initiating species generated from a cationic polymerization initiator, which will be described later, may be used. Moreover, the cationically polymerizable compound may be a monofunctional compound or a polyfunctional compound.

As the cationically polymerizable compound that can be used in the present invention, from the viewpoint of curability and abrasion resistance, a cyclic ether group-containing compound and/or a vinyloxy group-containing compound are preferable, and an epoxy group-containing compound, an oxetanyl-group containing compound and/or a vinyloxy group-containing compound are more preferable, and an epoxy group-containing compound and/or an oxetanyl-group containing compound are more preferable.

Furthermore, the coating composition of the present invention particularly preferably comprises both the epoxy group-containing compound and the oxetanyl-group containing compound.

In the present invention, the epoxy group-containing compound (hereinafter, also called an ‘oxirane compound’ as appropriate) is a compound containing at least one oxirane ring (oxiranyl group, epoxy group) per molecule; it may be appropriately selected from those normally used as epoxy resins, and specific examples thereof include conventionally known aromatic epoxy resins, alicyclic epoxy resins, and aliphatic epoxy resins. It may be any one of a monomer, an oligomer, and a polymer. Furthermore, the oxetanyl-group containing compound (hereinafter, also called an ‘oxetane compound’ as appropriate) is a compound containing at least one oxetane ring (oxetanyl group) per molecule.

The cationically polymerizable compound used in the present invention is now explained in detail.

Examples of the cationically polymerizable monomer include epoxy compounds, vinyl ether compounds, oxetane compounds described in JP-A-6-9714, JP-A-2001-31892, JP-A-2001-40068, JP-A-2001-55507, JP-A-2001-310938, JP-A-2001-310937, JP-A-2001-220526, etc.

Examples of monofunctional epoxy compounds include phenyl glycidyl ether, p-tert-butylphenyl glycidyl ether, butyl glycidyl ether, 2-ethylhexyl glycidyl ether, allyl glycidyl ether, 1,2-butylene oxide, 1,3-butadiene monooxide, 1,2-epoxydodecane, epichlorohydrin, 1,2-epoxydecane, styrene oxide, cyclohexene oxide, 3-methacryloyloxymethylcyclohexene oxide, 3-acryloyloxymethylcyclohexene oxide, and 3-vinylcyclohexene oxide.

Furthermore, examples of polyfunctional epoxy compounds include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resins, hydrogenated bisphenol A diglycidyl ether, hydrogenated bisphenol F diglycidyl ether, hydrogenated bisphenol S diglycidyl ether, 3,4-epoxycyclohexenylmethyl-3′,4′-epoxycyclohexenecarboxylate, 2-(3,4-epoxycyclohexyl)-7,8-epoxy-1,3-dioxaspiro[5.5]undecane, bis(3,4-epoxycyclohexylmethyl)adipate, vinylcyclohexene oxide, 4-vinylepoxycyclohexane, bis(3,4-epoxy-6-methylcyclohexylmethyl)adipate, 3,4-epoxy-6-methylcyclohexenyl 3′,4′-epoxy-6′-methylcyclohexenecarboxylate, methylenebis(3,4-epoxycyclohexane), dicyclopentadiene diepoxide, the di(3,4-epoxycyclohexylmethyl)ether of ethylene glycol, ethylene bis(3,4-epoxycyclohexanecarboxylate), dioctyl epoxyhexahydrophthalate, di-2-ethylhexyl epoxyhexahydrophthalate, 1,4-butanediol diglycidyl ether, 1,6-hexanediol diglycidyl ether, glycerol triglycidyl ether, trimethylolpropane triglycidyl ether, polyethylene glycol diglycidyl ether, polypropylene glycol diglycidyl ether, 1,13-tetradecadiene dioxide, limonene dioxide, 1,2,7,8-diepoxyoctane, and 1,2,5,6-diepoxycyclooctane.

Among these epoxy compounds, the aromatic epoxides and the alicyclic epoxides are preferable from the viewpoint of excellent curing speed, and the alicyclic epoxides are particularly preferable.

Examples of monofunctional vinyl ethers include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexylmethyl vinyl ether, 4-methylcyclohexylmethyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, and phenoxypolyethylene glycol vinyl ether.

Furthermore, examples of polyfunctional vinyl ethers include divinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ether, and bisphenol F alkylene oxide divinyl ether; and polyfunctional vinyl ethers such as trimethylolethane trivinyl ether, trimethylolpropane trivinyl ether, ditrimethylolpropane tetravinyl ether, glycerol trivinyl ether, pentaerythritol tetravinyl ether, dipentaerythritol pentavinyl ether, dipentaerythritol hexavinyl ether, an ethylene oxide adduct of trimethylolpropane trivinyl ether, a propylene oxide adduct of trimethylolpropane trivinyl ether, an ethylene oxide adduct of ditrimethylolpropane tetravinyl ether, a propylene oxide adduct of ditrimethylolpropane tetravinyl ether, an ethylene oxide adduct of pentaerythritol tetravinyl ether, a propylene oxide adduct of pentaerythritol tetravinyl ether, an ethylene oxide adduct of dipentaerythritol hexavinyl ether, and a propylene oxide adduct of dipentaerythritol hexavinyl ether.

As the vinyl ether compound, the di- or tri-vinyl ether compounds are preferable from the viewpoint of curability, adhesion to a recording medium, surface hardness of the image formed, etc., and the divinyl ether compounds are particularly preferable.

The oxetane compound that can be used in the present invention may be selected freely from known oxetane compounds such as those described in JP-A-2001-220526, JP-A-2001-310937, and JP-A-2003-341217.

As the compound having an oxetane ring that can be used in the present invention, a compound having 1 to 4 oxetane rings in the structure is preferable.

Examples of monofunctional oxetane compounds used in the present invention include 3-ethyl-3-hydroxymethyloxetane, 3-allyloxymethyl-3-ethyloxetane, (3-ethyl-3-oxetanylmethoxy)methylbenzene, 4-fluoro-[1-(3-ethyl-3-oxetanylmethoxy)methyl]benzene, 4-methoxy-[1-(3-ethyl-3-oxetanylmethoxy)methyl]benzene, [1-(3-ethyl-3-oxetanylmethoxy)ethyl]phenyl ether, isobutoxymethyl(3-ethyl-3-oxetanylmethyl)ether, isobornyloxyethyl(3-ethyl-3-oxetanylmethyl)ether, isobornyl(3-ethyl-3-oxetanylmethyl)ether, 2-ethylhexyl(3-ethyl-3-oxetanylmethyl)ether, ethyl diethylene glycol(3-ethyl-3-oxetanylmethyl)ether, dicyclopentadiene(3-ethyl-3-oxetanylmethyl)ether, dicyclopentenyloxyethyl(3-ethyl-3-oxetanylmethyl)ether, dicyclopentenyl(3-ethyl-3-oxetanylmethyl)ether, tetrahydrofurfuryl(3-ethyl-3-oxetanylmethyl)ether, tetrabromophenyl(3-ethyl-3-oxetanylmethyl)ether, 2-tetrabromophenoxyethyl(3-ethyl-3-oxetanylmethyl)ether, tribromophenyl(3-ethyl-3-oxetanylmethyl)ether, 2-tribromophenoxyethyl(3-ethyl-3-oxetanylmethyl)ether, 2-hydroxyethyl(3-ethyl-3-oxetanylmethyl)ether, 2-hydroxypropyl(3-ethyl-3-oxetanylmethyl)ether, butoxyethyl(3-ethyl-3-oxetanylmethyl)ether, pentachlorophenyl(3-ethyl-3-oxetanylmethyl)ether, pentabromophenyl(3-ethyl-3-oxetanylmethyl)ether, and bornyl(3-ethyl-3-oxetanylmethyl)ether.

Examples of polyfunctional oxetane compounds include 3,7-bis(3-oxetanyl)-5-oxanonane, 3,3′-(1,3-(2-methylenyl)propanediylbis(oxymethylene))bis-(3-ethyloxetane), 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl)ether, dicyclopentenylbis(3-ethyl-3-oxetanylmethyl)ether, triethylene glycol bis(3-ethyl-3-oxetanylmethyl)ether, tetraethylene glycol bis(3-ethyl-3-oxetanylmethyl)ether, tricyclodecanediyldimethylene(3-ethyl-3-oxetanylmethyl)ether, trimethylolpropane tris(3-ethyl-3-oxetanylmethyl)ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl)ether, pentaerythritol tetrakis(3-ethyl-3-oxetanylmethyl)ether, polyethylene glycol bis(3-ethyl-3-oxetanylmethyl)ether, dipentaerythritol hexakis(3-ethyl-3-oxetanylmethyl)ether, dipentaerythritol pentakis(3-ethyl-3-oxetanylmethyl)ether, dipentaerythritol tetrakis(3-ethyl-3-oxetanylmethyl)ether, caprolactone-modified dipentaerythritol hexakis(3-ethyl-3-oxetanylmethyl)ether, caprolactone-modified dipentaerythritol pentakis(3-ethyl-3-oxetanylmethyl)ether, ditrimethylolpropane tetrakis(3-ethyl-3-oxetanylmethyl)ether, ethylene oxide (EO)-modified bisphenol A bis(3-ethyl-3-oxetanylmethyl)ether, propylene oxide (PO)-modified bisphenol A bis(3-ethyl-3-oxetanylmethyl)ether, EO-modified hydrogenated bisphenol A bis(3-ethyl-3-oxetanylmethyl)ether, PO-modified hydrogenated bisphenol A bis(3-ethyl-3-oxetanylmethyl)ether, and EO-modified bisphenol F (3-ethyl-3-oxetanylmethyl)ether.

Such oxetane compounds are described in detail in Paragraph Nos. 0021 to 0084 of JP-A-2003-341217, and compounds described therein can be used suitably in the present invention.

Among the oxetane compounds that can be used in the present invention, it is preferable to use a compound having 1 to 4 oxetane rings and it is more preferable to use a compound having 1 to 2 oxetane rings.

In the present invention, with regard to these cationically polymerizable compounds, one type thereof may be used or two or more types may be used in combination.

From the viewpoint of curability and surface smoothness, the content of cationically polymerizable compound in the photocurable coating composition of the present invention, relative to the total weight of the coating composition, is preferably in the range of 10 to 97 wt %, more preferably in the range of 30 to 95 wt %, and particularly preferably in the range of 50 to 90 wt %.

The coating composition of the present invention may be a radical-cationic hybrid type coating composition that comprises in combination a radically polymerizable compound, which is described later, and a cationically polymerizable compound.

### Radically Polymerizable Compound

The coating composition of the present invention may comprise in combination a cationically polymerizable compound and a radically polymerizable compound.

The radically polymerizable compound that can be used in the present invention is preferably a compound having an ethylenically unsaturated group.

The radically polymerizable compound in the present invention may be any compound as long as it has at least one ethylenically unsaturated group, and those having a chemical form such as monomer, oligomer, or polymer are included.

With regard to the radically polymerizable compound, one type thereof may be used on its own, or two or more types thereof may be used in combination at any ratio in order to improve intended properties. From the viewpoint of controlling performance such as reactivity and physical properties, it is preferable to use two or more types of radically polymerizable compounds in combination.

The specific examples of the radically polymerizable compounds include unsaturated carboxylic acids such as acrylic acid, methacrylic acid, itaconic acid, crotonic acid, isocrotonic acid, and maleic acid, and salts thereof, anhydrides having an ethylenically unsaturated group, acrylonitrile, styrene, and various unsaturated polyesters, unsaturated polyethers, unsaturated polyamides, and unsaturated urethanes.

Specific examples thereof include acrylic acid derivatives such as methyl acrylate, ethyl acrylate, n-butyl acrylate, 2-ethylhexyl acrylate, 2-hydroxyethyl acrylate, butoxyethyl acrylate, carbitol acrylate, cyclohexyl acrylate, tetrahydrofurfuryl acrylate, benzyl acrylate, bis(4-acryloxypolyethoxyphenyl)propane, neopentyl glycol diacrylate, 1,6-hexanediol diacrylate, ethylene glycol diacrylate, diethylene glycol diacrylate, triethylene glycol diacrylate, tetraethylene glycol diacrylate, polyethylene glycol diacrylate, polypropylene glycol diacrylate, pentaerythritol triacrylate, pentaerythritol tetraacrylate, dipentaerythritol tetraacrylate, trimethylolpropane triacrylate, tetramethylolmethane tetraacrylate, oligoester acrylate, N-methylolacrylamide, diacetoneacrylamide, and epoxyacrylate, methacrylic derivatives such as methyl methacrylate, ethyl methacrylate, n-butyl methacrylate, 2-ethylhexyl methacrylate, lauryl methacrylate, allyl methacrylate, glycidyl methacrylate, benzyl methacrylate, dimethylaminomethyl methacrylate, 1,6-hexanediol dimethacrylate, ethylene glycol dimethacrylate, triethylene glycol dimethacrylate, polyethylene glycol dimethacrylate, polypropylene glycol dimethacrylate, trimethylolethane trimethacrylate, trimethylolpropane trimethacrylate, and 2,2-bis(4-methacryloxypolyethoxyphenyl)propane, N-vinyl compounds such as N-vinylpyrrolidone and N-vinylcaprolactam, allyl compound derivatives such as allyl glycidyl ether, diallyl phthalate, and triallyl trimellitate and, more specifically, radically polymerizable or crosslinking monomers, oligomers, and polymers that are commercial products or are industrially known, such as those described in ‘Kakyozai Handobukku’ (Crosslinking Agent Handbook), Ed. S. Yamashita (Taiseisha, 1981); ‘UV•EB Koka Handobukku’ (UV•EB Curing Handbook) (Starting Materials) Ed. K. Kato (Kobunshi Kankoukai, 1985); ‘UV•EB Koka Gijutsu no Oyo to Shijyo’ (Application and Market of UV•EB Curing Technology), p. 79, Ed. Rad Tech (CMC, 1989); and E. Takiyama ‘Poriesuteru Jushi Handobukku’ (Polyester Resin Handbook), (The Nikkan Kogyo Shimbun Ltd., 1988) may be used.

Furthermore, as the radically polymerizable compound, photocuring polymerizable compound materials used in photopolymerizable compositions described in, for example, JP-A-7-159983, JP-B-7-31399 (JP-B denotes a Japanese examined patent application publication), JP-A-8-224982, JP-A-10-863, JP-A-9-134011, etc. are known, and they may be used in the coating composition of the present invention.

### Radical Photopolymerization Initiator

When a radically polymerizable compound is used in combination in the coating composition of the present invention, it is preferable to use a radical photopolymerization initiator and a cationic photopolymerization initiator in combination

Preferred examples of the radical photopolymerization initiator that can be used in the present invention include (a) aromatic ketones, (b) acylphosphine compounds, (c) aromatic onium salt compounds, (d) organic peroxides, (e) thio compounds, (f) hexaarylbiimidazole compounds, (g) ketoxime ester compounds, (h) borate compounds, (i) azinium compounds, (j) metallocene compounds, (k) active ester compounds, (l) carbon-halogen bond-containing compounds, and (m) alkylamine compounds.

As a photopolymerization initiator that is preferable from the viewpoint of transparency, when the photopolymerization initiator is made into a 3 g/cm² thick film, a compound with an absorbance at a wavelength of 400 nm of no greater than 0.3 is preferable; it is more preferably no greater than 0.2, and yet more preferably no greater than 0.1.

Among the above, as a preferred photopolymerization initiator, there can be cited (a) aromatic ketones, (b) acylphosphine compounds, and (c) aromatic onium salt compounds.

### Sensitizer

A sensitizer may be added to the coating composition of the present invention in order to promote decomposition of the photopolymerization initiator by irradiation with actinic radiation.

The sensitizer absorbs specific actinic radiation and attains an electronically excited state. The sensitizer in the electronically excited state contacts the photopolymerization initiator and causes an action such as electron transfer, energy transfer, or generation of heat, thereby promoting chemical change of the photopolymerization initiator, that is, decomposition and generation of a radical, an acid, or a base.

With regard to the sensitizer that can be used in the present invention, it is preferable to use a compound or an amount for which effects such as coloring are small when the coating composition of the present invention is used in an overprint.

The content of the sensitizer in the present invention, relative to the total weight of the coating composition, is preferably 0.001 to 5 wt %, and more preferably 0.01 to 3 wt %. When the amount thereof added is in this range, the curability improves and there is little coloring effect.

As the sensitizer, a compound may be used that is appropriate for the wavelength of actinic radiation that generates an initiating species in the photopolymerization initiator used, but taking into consideration use in a curing reaction of a normal coating composition, preferred examples of the sensitizer include the types of compounds that come under those listed below and that have an absorption wavelength in the range of 350 nm to 450 nm.

Polynuclear aromatic compounds (e.g. pyrene, perylene, triphenylene), xanthenes (e.g. fluorescein, eosin, erythrosine, rhodamine B, rose bengal), cyanines (e.g. thiacarbocyanine, oxacarbocyanine), merocyanines (e.g. merocyanine, carbomerocyanine), thiazines (e.g. thionine, methylene blue, toluidine blue), acridines (e.g. acridine orange, chloroflavin, acriflavine), anthraquinones (e.g. anthraquinone), squaryliums (e.g. squarylium), coumarins (e.g. 7-diethylamino-4-methylcoumarin), and benzophenones (e.g. benzophenone).

Preferred examples of the sensitizer include compounds represented by Formulae (II) to (VI) below.

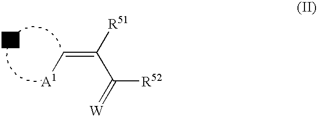

In Formula (II), A¹ denotes a sulfur atom or NR⁵⁰, R⁵⁰ denotes an alkyl group or an aryl group, L² denotes a non-metallic atomic group forming a basic nucleus in cooperation with the adjacent A¹ and carbon atom, R⁵¹ and R⁵² independently denote a hydrogen atom or a monovalent non-metallic atomic group, and R⁵¹ and R⁵² may be bonded together to form an acidic nucleus. W denotes an oxygen atom or a sulfur atom.

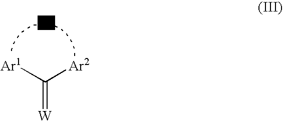

In Formula (III), Ar¹ and Ar² independently denote an aryl group and are connected to each other via bonding to -L³-. Here, L³ denotes —O— or —S—. W has the same meaning as that shown in Formula (II).

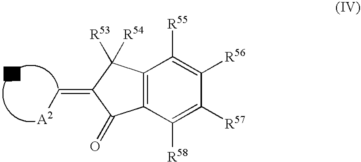

In Formula (IV), A² denotes a sulfur atom or NR⁵⁹, L⁴ denotes a non-metallic atomic group forming a basic nucleus in cooperation with the adjacent A² and carbon atom, R⁵³, R⁵⁴, R⁵⁵, R⁵⁶, R⁵⁷, and R⁵⁸ independently denote a monovalent non-metallic atomic group, and R⁵⁹ denotes an alkyl group or an aryl group.

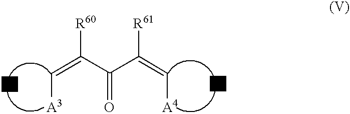

In Formula (V), A³ and A⁴ independently denote —S—, —NR⁶²—, or —NR⁶³—, R⁶² and R⁶³ independently denote a substituted or unsubstituted alkyl group, or a substituted or unsubstituted aryl group, L⁵ and L⁶ independently denote a non-metallic atomic group forming a basic nucleus in cooperation with the adjacent A³ and A⁴ and adjacent carbon atom, and R⁶⁰ and R⁶¹ independently denote a hydrogen atom or a monovalent non-metallic atomic group, or are bonded to each other to form an aliphatic or aromatic ring.

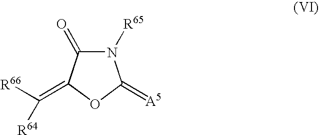

In Formula (VI), R⁶⁶ denotes an optionally substituted aromatic ring or hetero ring, and A⁵ denotes an oxygen atom, a sulfur atom, or NR⁶⁷. R⁶⁴, R⁶⁵, and R⁶⁷ independently denote a hydrogen atom or a monovalent non-metallic atomic group, and R⁶⁷ and R⁶⁴, and R⁶⁵ and R⁶⁷ may be bonded to each other to form an aliphatic or aromatic ring.

Preferred specific examples of the compound represented by Formulae (II) to (VI) are listed below. In the specific example listed below, ‘Ph’ denotes a phenyl group and ‘Me’ denotes a methyl group.

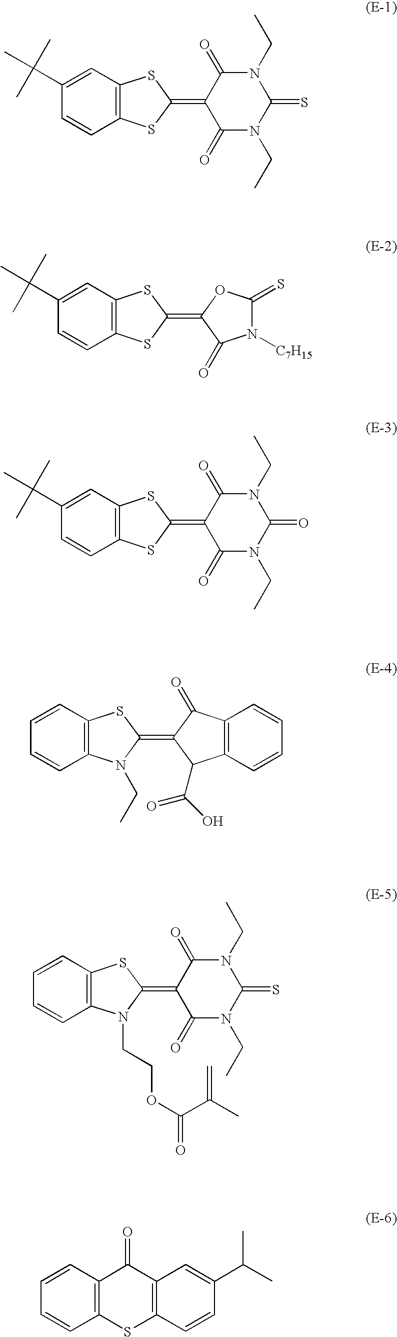

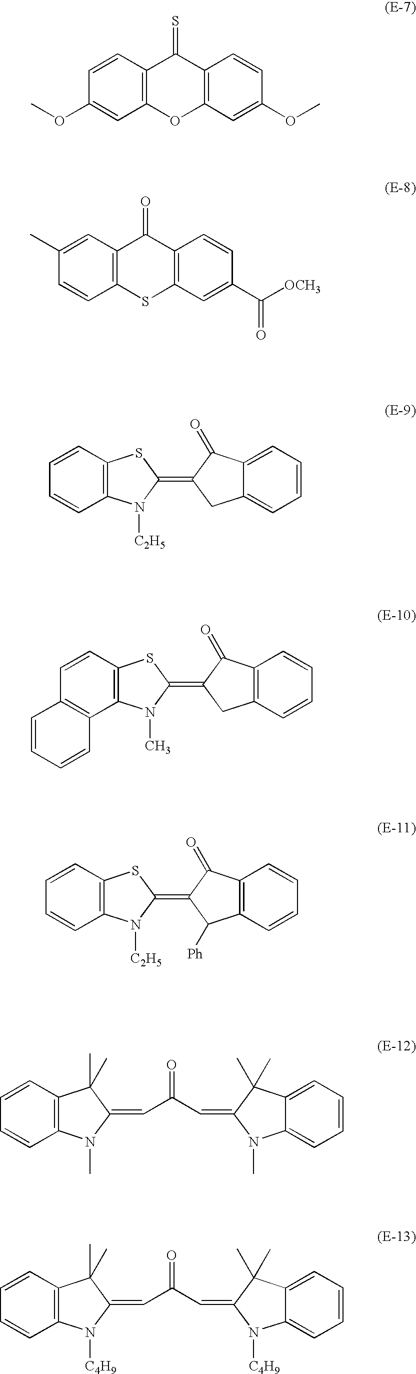

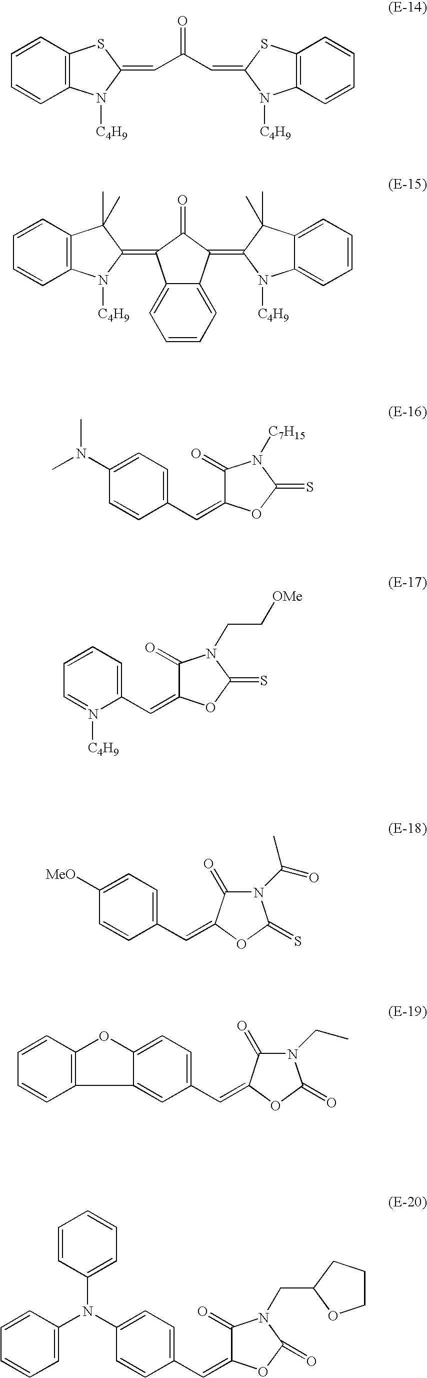

### Co-Sensitizer

The coating composition of the present invention may comprise a co-sensitizer.

In the present invention, the co-sensitizer has a function of further improving the sensitivity of a sensitizer toward actinic radiation, suppressing inhibition of polymerization of a polymerizable compound by oxygen, etc.

Examples of such a co-sensitizer include amines such as compounds described in M. R. Sander et al., Journal of Polymer Society, Vol. 10, p. 3173 (1972), JP-B-44-20189, JP-A-51-82102, JP-A-52-134692, JP-A-59-138205, JP-A-60-84305, JP-A-62-18537, JP-A-64-33104, and Research Disclosure 33825.

Specific examples thereof include triethanolamine, ethyl p-dimethylaminobenzoate, p-formyldimethylaniline, and p-methylthiodimethylaniline.

Other examples of the co-sensitizer include thiols and sulfides such as thiol compounds described in JP-A-53-702, JP-PCT-55-500806 (JP-PCT denotes a published Japanese translation of a PCT application), and JP-A-5-142772, and disulfide compounds described in JP-A-56-75643.

Specific examples thereof include 2-mercaptobenzothiazole, 2-mercaptobenzoxazole, 2-mercaptobenzoimidazole, 2-mercapto-4(3H)-quinazoline, and β-mercaptonaphthalene.

Other examples thereof include amino acid compounds (e.g. N-phenylglycine), organometallic compounds described in JP-B-48-42965 (e.g. tributyltin acetate), hydrogen donors described in JP-B-55-34414, sulfur compounds described in JP-A-6-308727 (e.g. trithiane), phosphorus compounds described in JP-A-6-250387 (e.g. diethylphosphite), and Si—H and Ge—H compounds described in JP-A-8-54735.

### Surfactant

The coating composition of the present invention may comprise a surfactant.

As the surfactant, those described in JP-A-62-173463 and JP-A-62-183457 can be cited. Examples thereof include anionic surfactants such as dialkylsulfosuccinic acid salts, alkylnaphthalenesulfonic acid salts, and fatty acid salts, nonionic surfactants such as polyoxyethylene alkyl ethers, polyoxyethylene alkyl aryl ethers, acetylene glycols, and polyoxyethylene/polyoxypropylene block copolymers, and cationic surfactants such as alkylamine salts and quaternary ammonium salts. An organofluoro compound or a polysiloxane compound may be used as the surfactant. The organofluoro compound is preferably hydrophobic. Examples of the organofluoro compound include fluorine-based surfactants, oil-like fluorine-based compounds (e.g. fluorine oil), solid fluorine compound resins (e.g. tetrafluoroethylene resin), and those described in JP-B-57-9053 (paragraphs 8 to 17) and JP-A-62-135826. Among them, polydimethylsiloxane is preferable as the surfactant.

With regard to these surfactants, one type thereof may be used on its own or two or more types may be used in combination.

### Other Components

Other components may be added to the coating composition of the present invention as necessary. Examples of said other components include a polymerization inhibitor, a solvent, inorganic particles, and organic particles.

The polymerization inhibitor may be added from the viewpoint of enhancing the storage stability. The polymerization inhibitor is preferably added at 200 to 20,000 ppm relative to the total amount of the coating composition of the present invention.

Examples of the polymerization inhibitor include hydroquinone, benzoquinone, p-methoxyphenol, TEMPO, TEMPOL, and Al cupferron.

It is possible to form an overprint layer or an overprint with intentionally degraded surface gloss by adding inorganic particles such as AEROSIL (silicon dioxide particles, manufactured by Degussa Inc.) or organic particles such as crosslinked polymethyl methacrylate (PMMA) to the coating composition of the present invention.

Taking into consideration the coating composition of the present invention being a radiation curable type coating composition, it is preferable for it not to contain any solvent so that the coating composition of the present invention can react quickly and be cured after coating. However, as long as the curing speed, etc. of the coating composition is not greatly affected, a specified solvent may be added.

In the present invention, an organic solvent may be used as the solvent, and from the viewpoint of curing speed, it is preferable for substantially no water to be added. The organic solvent may be added in order to improve adhesion to a printing substrate (an image receiving substrate such as paper).

When an organic solvent is used, the smaller the amount thereof, the more preferable it is, and it is preferably 0.1 to 5 wt % relative to the total weight of the coating composition of the present invention, and more preferably 0.1 to 3 wt %.

In addition to the above, a known compound may be added to the coating composition of the present invention as necessary.

Examples thereof include a leveling additive, a matting agent and, for adjusting film physical properties, a polyester-based resin, polyurethane-based resin, vinyl-based resin, acrylic-based resin, rubber-based resin, or wax, which may be appropriately selected and added.

Furthermore, in order to improve the adhesion to a printing substrate such as a polyolefin or polyethylene terephthalate (PET), a tackifier that does not inhibit polymerization is preferably added. Specific examples of the tackifier include high molecular weight tacky polymers described on pp. 5 and 6 of JP-A-2001-49200 (e.g. a copolymer formed from an ester of (meth)acrylic acid and an alcohol having an alkyl group having 1 to 20 carbons, an ester of (meth)acrylic acid and an alicyclic alcohol having 3 to 14 carbons, or an ester of (meth)acrylic acid and an aromatic alcohol having 6 to 14 carbons), and a low molecular weight tackifying resin having a polymerizable unsaturated group.

### Properties of Photocurable Coating Composition

Preferred physical properties of the photocurable coating composition of the present invention are now explained.

When used as a photocurable coating composition, while taking into consideration coating properties, the viscosity at 25° C. to 30° C. is preferably 5 to 100 mPa·s, and more preferably 7 to 75 mPa·s.

The compositional ratio of the photocurable coating composition of the present invention is preferably adjusted as appropriate so that the viscosity is in the above range.

Setting the viscosity at 25° C. to 30° C. at the above value enables an overprint having an overprint layer with excellent non-tackiness (no surface tackiness) and excellent surface smoothness to be obtained.

The surface tension of the photocurable coating composition of the present invention is preferably 16 to 40 mN/m, and more preferably 18 to 35 mN/m.

### Overprint and Process for Producing Same

The overprint of the present invention has, on a printed material, an overprint layer in which the coating composition of the present invention is photocured.

The overprint referred to here is one in which at least one overprint layer is formed on the surface of a printed material obtained by a printing method such as electrophotographic printing, inkjet printing, screen printing, flexographic printing, lithographic printing, intaglio printing, or relief printing.

The overprint layer in the overprint of the present invention may be formed on part of a printed material or may be formed on the entire surface of a printed material, and in the case of a double-side printed material, it is preferable to form the overprint layer on the entire surface of a printing substrate on both sides. Furthermore, needless to say, the overprint layer may be formed on an unprinted area of a printed material.

A printed material used for the overprint of the present invention is preferably an electrophotographically printed material. Forming an overprint layer, which is a cured layer of the coating composition of the present invention, on an electrophotographically printed material enables an overprint that has excellent non-tackiness, surface smoothness, and gloss and is visually similar to a silver halide photographic print to be obtained.

Furthermore, since the overprint of the present invention has an excellent no n-tackiness, the overprints do not stick each other and a good storage property can be obtained if a plurality of the overprints of the present invention is piled up for a long time.

The thickness of the overprint layer in the overprint of the present invention is preferably 1 to 10 μm, and more preferably 3 to 6 μm.

A method for measuring the thickness of the overprint layer is not particularly limited, but preferred examples thereof include a measurement method in which a cross section of an overprint is examined using an optical microscope, etc.

The process for producing an overprint of the present invention preferably comprises a step of obtaining a printed material by carrying out printing on a printing substrate, a step of coating the printed material with the photocurable coating composition of the present invention, and a step of photocuring the photocurable coating composition.

Furthermore, the process for producing an overprint of the present invention preferably comprises a step of generating an electrostatic latent image on a latent image support, a step of developing the electrostatic latent image using a toner, a step of obtaining an electrophotographically printed material by transferring the developed electrostatic image onto a printing substrate, a step of coating the electrophotographically printed material with the photocurable coating composition of the present invention, and a step of photocuring the photocurable coating composition.

The printing substrate is not particularly limited, and a known substrate may be used, but an image receiving paper is preferable, plain paper or coated paper is more preferable, and coated paper is yet more preferable. As the coated paper, a double-sided coated paper is preferable since a full color image can be attractively printed on both sides. When the printing substrate is paper or a double-sided coated paper, the paper weight is preferably 20 to 200 g/m², and more preferably 40 to 160 g/m².

A method for developing an image in the electrophotographic process is not particularly limited, and any method may be selected from methods known to a person skilled in the art. Examples thereof include a cascade method, a touch down method, a powder cloud method, and a magnetic brush method.

Furthermore, examples of a method for transferring a developed image to a printing substrate include a method employing a corotron or a bias roll.

A fixing step of fixing an image in the electrophotographic process may be carried out by various appropriate methods. Examples thereof include flash fixing, thermal fixing, pressure fixing, and vapor fusing.

The image formation method, equipment, and system in the electrophotographic process are not particularly limited, and known ones may be used. Specific examples are described in the US patents below.

U.S. Pat. Nos. 4,585,884, 4,584,253, 4,563,408, 4,265,990, 6,180,308, 6,212,347, 6,187,499, 5,966,570, 5,627,002, 5,366,840, 5,346,795, 5,223,368, and 5,826,147.

In order to apply the photocurable coating composition, a commonly used liquid film coating device may be used. Specific examples thereof include a roller coater, a rod coater, a blade, a wire-wound bar, a dip coater, an air knife, a curtain coater, a slide coater, a doctor knife, a screen coater, a gravure coater, an offset gravure coater, a slot coater, and an extrusion coater. These devices may be used in the same manner as normal, and examples thereof include direct and reverse roll coating, blanket coating, dampener coating, curtain coating, lithographic coating, screen coating, and gravure coating. In a preferred embodiment, application and curing of the coating composition of the present invention are carried out using 2 or 3 roll coaters and UV curing stations.

Moreover, when coating or curing the coating composition of the present invention, heating may be carried out as necessary.

The coat weight of the coating composition of the present invention is preferably in the range of 1 to 10 g/m² as a weight per unit area, and more preferably 3 to 6 g/m².

Furthermore, the amount per unit area of an overprint layer formed in the overprint of the present invention is preferably in the range of 1 to 10 g/m², and more preferably 3 to 6 g/m².

As an energy source used for initiating polymerization of the polymerizable compound contained in the coating composition of the present invention, for example, one having actinism (actinic radiation) such as radiation having a wavelength in the UV or visible spectrum can be cited. Polymerization by irradiation with actinic radiation is excellent for initiating polymerization and regulating the speed of polymerization.

As a preferred actinic radiation source, for example, there are a mercury lamp, a xenon lamp, a carbon arc lamp, a tungsten filament lamp, a laser, and sunlight.

It is preferable to carry out irradiation using a high speed conveyor (preferably 20 to 70 m/min) under irradiation with UV rays (UV light irradiation) using a medium pressure mercury lamp, and in this case UV light irradiation is preferably carried out at a wavelength of 200 to 500 nm for less than 1 sec. Preferably, the speed of the high speed conveyor is 15 to 35 m/min, and UV light having a wavelength of 200 to 450 nm is applied for 10 to 50 milliseconds (ms). The emission spectrum of a UV light source normally overlaps the absorption spectrum of a UV polymerization initiator. Depending on the situation, curing equipment used may include, without being limited to, a reflection plate for focusing or diffusing UV light or a cooling system for removing heat generated by a UV light source.

### Properties of Cured Material of Photocurable Coating

A cured material formed by curing the photocurable coating composition of the present invention by irradiation with UV rays (UV light irradiation) preferably has substantially no absorption in the visible region. ‘Having substantially no absorption in the visible region’ means either having no absorption in the visible region of 400 to 700 nm or having only a level of absorption in the visible region that does not cause any problem as a photocurable coating. Specifically, a 5 μm optical path length transmittance of the coating composition in the wavelength region of 400 to 700 nm is at least 70%, and preferably at least 80%.

In accordance with the present invention, there can be provided a photocurable coating composition giving excellent surface smoothness, non-tackiness (suppression of surface tackiness), and suppression of odor, an overprint obtained by using the photocurable coating composition, and a process for producing same.

### EXAMPLES

The present invention is explained more specifically below by reference to Examples, but the present invention should not be construed as being limited by modes of these Examples.

### Synthesis of Specific Fluorine Polymer (F-5)

A solution of R-1620 (Daikin Industries, Ltd.) (0.2 mol), glycidyl methacrylate (0.8 mol), and 2,2′-azobis(2-methylbutyronitrile) (AIBN, Wako Pure Chemical Industries, Ltd.) (0.01 mol) in 1-methoxy-2-propanol (300 g) was added dropwise to 1-methoxy-2-propanol (300 g) at 80° C. over 4 hours under a flow of nitrogen. After completion of the dropwise addition, stirring was further carried out at 85° C. for 3 hours, thus giving specific fluorine polymer (F-5). When the specific fluorine polymer (F-5)) was measured by gel permeation chromatography (GPC), the weight-average molecular weight was found to be 23,000. The structure of the specific fluorine polymer (F-5) thus obtained was identified by NMR.

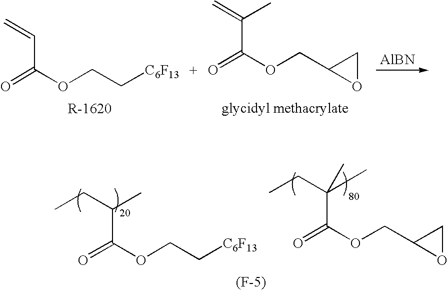

Specific fluorine polymers (F-1) to (F-4), (F-6) to (F-24), and comparative polymers (Z-1) to (Z-4) were synthesized by the same method as above.

Structural formulae of comparative polymers (Z-1) to (Z-4) were as follows.

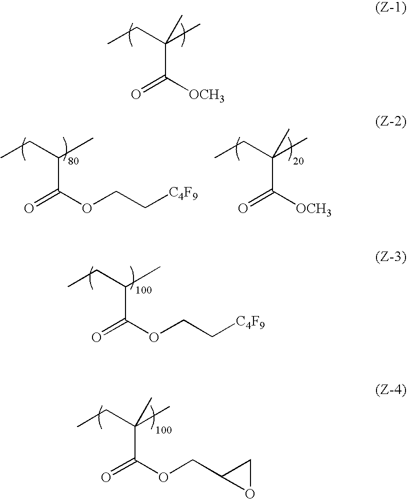

### Example 1

The components below were stirred using a stirrer to give photocurable overprint composition 1.

3,4-Epoxycyclohexylmethyl-3′,4′-epoxycyclohexanecarboxylate (Celloxide 2021: Daicel-UCB Co., Ltd.): 25 wt %
3,7-Bis(3-oxetanyl)-5-oxanonane (OXT-221: Toagosei Co., Ltd.): 40 wt %
3-Ethyl-3-phenoxymethyloxetane (OXT-211: Toagosei Co., Ltd.): 20 wt %

### UVI-6992 (The Dow Chemical Company): 10 wt %

### Anthracene: 2 wt %

Specific fluorine polymer (F-1): 3 wt %

### Examples 2 to 10

In Examples 2 to 10, photocurable coating compositions were obtained in the same manner as in Example 1 except that the specific fluorine polymer (F-1) was changed to a compound (polymer) given in Table 1.

### Comparative Example 1

The components below were stirred using a stirrer to give comparative photocurable overprint composition 1.

3,4-Epoxycyclohexylmethyl-3′,4′-epoxycyclohexanecarboxylate (Celloxide 2021: Daicel-UCB Co., Ltd.): 25 wt %
3,7-Bis(3-oxetanyl)-5-oxanonane (OXT-221: Toagosei Co., Ltd.): 40 wt %
3-Ethyl-3-phenoxymethyloxetane (OXT-211: Toagosei Co., Ltd.): 20 wt %

### UVI-6992 (The Dow Chemical Company): 10 wt %

### Anthracene: 2 wt %

Comparative polymer (Z-1): 3 wt %

### Comparative Examples 2 to 4

In Comparative Examples 2 to 4, photocurable overprint compositions were obtained in the same manner as in Comparative Example 1 except that the comparative polymer (Z-1) was changed to a compound given in Table 1.

### Comparative Example 5

The components below were stirred using a stirrer to give comparative photocurable coating composition 1.

3,4-Epoxycyclohexylmethyl-3′,4′-epoxycyclohexanecarboxylate (Celloxide 2021: Daicel-UCB Co., Ltd.): 25 wt %
3,7-Bis(3-oxetanyl)-5-oxanonane (OXT-221: Toagosei Co., Ltd.): 40 wt %
3-Ethyl-3-phenoxymethyloxetane (OXT-211: Toagosei Co., Ltd.): 23 wt %

### UVI-6992 (The Dow Chemical Company): 10 wt %

### Anthracene: 2 wt %

### Evaluation of Performance

Evaluation of the performance of the photocurable coating compositions of Examples 1 to 10 and Comparative Examples 1-5 thus obtained was carried out by the following methods.

### Evaluation of Surface Smoothness (Leveling Properties)

An electrophotographically printed material obtained using double-sided coated paper output from a DC8000 digital printer manufactured by Fuji Xerox Co., Ltd. was coated on one side with the coating composition at a film thickness of 5 g/m² using an SG610V UV varnish coater manufactured by Shinano Kenshi Co., Ltd., and was subsequently exposed at 120 mJ/cm² with an illumination intensity of 1.0 W/cm², thus giving an overprint sample. The condition of the surface of the coated printed material was visually evaluated in terms of the occurrence of longitudinal lines. The evaluation criteria are shown below.

Excellent: no longitudinal lines.
Good: slight longitudinal lines observed.
Fair: longitudinal lines remained but at a level that was not a problem in practice.
Poor: many longitudinal lines observed at a level that caused a problem in practice.

### Evaluation of Non-Tackiness (Suppression of Surface Tackiness)

An electrophotographically printed material obtained using double-sided coated paper output from a DC8000 digital printer manufactured by Fuji Xerox Co., Ltd. was coated on one side with the coating composition at a film thickness of 5 g/m² using a bar coater, and the film coating thus obtained was exposed at 120 mJ/cm² with an illumination intensity of 1.0 W/cm² using an LC8 UV lamp manufactured by Hamamatsu Photonics K.K., thus giving an overprint sample. The non-tackiness after light exposure was evaluated by touch. The evaluation criteria are shown below.

Excellent: no tackiness
Good: almost no tackiness
Fair: slight tackiness
Poor: surface uncured

TABLE 1

| | Specific | | | | |
|---|---|---|---|---|---|
| | compound | Molecular | Surface | Non- | |
| | example | weight | smoothness | tackiness | Odor |
| Example 1 | F-1 | 31,000 | Excellent | Excellent | 5 |
| Example 2 | F-2 | 42,000 | Excellent | Excellent | 4 |
| Example 3 | F-5 | 23,000 | Excellent | Excellent | 5 |
| Example 4 | F-10 | 16,000 | Excellent | Excellent | 5 |
| Example 5 | F-11 | 8,000 | Excellent | Excellent | 5 |
| Example 6 | F-13 | 9,000 | Excellent | Excellent | 5 |
| Example 7 | F-14 | 11,000 | Excellent | Excellent | 4 |
| Example 8 | F-15 | 15,000 | Excellent | Excellent | 5 |
| Example 9 | F-22 | 22,000 | Excellent | Excellent | 5 |
| Example 10 | F-23 | 23,000 | Excellent | Excellent | 5 |
| Comparative | Z-1 | 15,000 | Poor | Poor | 2 |
| Example 1 | | | | | |
| Comparative | Z-2 | 36,000 | Excellent | Fair | 4 |
| Example 2 | | | | | |
| Comparative | Z-3 | 29,000 | Excellent | Poor | 4 |
| Example 3 | | | | | |
| Comparative | Z-6 | 19,000 | Poor | Poor | 2 |
| Example 4 | | | | | |
| Comparative | — | — | Poor | Poor | 1 |
| Example 5 | | | | | |

### Example 11

10 sheets of printed material were prepared by electrophotographically printing full color images, each having a few frames, on both sides of A4 double-sided coated paper (paper weight 100 g/m²), both sides of the printed materials were coated with the photocurable overprint compositions prepared in Examples 1 to 10 above by the same method as in Example 1 at a coat weight of 5 g/m², and then irradiated with UV rays, thus giving overprints. When they were bound to give a photo album, a photo album giving the same visibility as that given by a silver halide photographic print was obtained.

### Example 12

10 sheets of printed material were prepared by electrophotographically printing a full color image including a menu photograph and text on both sides of substantially A3 double-sided coated paper (paper weight 100 g/m²), both sides of the printed materials were coated with the photocurable overprint compositions prepared in Examples 1 to 10 above by the same method as in Example 1 at a coat weight of 5 g/m² per side, and then irradiated with UV rays, thus giving overprints on both sides. When they were bound to give a restaurant menu, a restaurant menu giving the same visibility as that given by a silver halide photographic print was obtained.

In Examples 1 to 12 above, the amount of overprint layer formed by coating one side of a printing substrate with a photocurable coating composition at a coat weight of 5 g/m² and curing it was 5 g/m² in each case.

Furthermore, the thickness of the overprint layer thus formed was about 5 μm in each case. The thickness of the overprint layer thus formed was measured by examining a cross section of the overprint using an optical microscope.

When the transmittance at an optical path length of 5 μm of the photocurable coating compositions used in Examples 1 to 12 was measured, the transmittance was 80% over the whole wavelength region of 400 nm to 700 nm in all cases.

When the transmittance at an optical path length of 5 μm of the cured material formed by the photocurable coating compositions used in Examples 1 to 12 was measured, the transmittance was 80% over the whole wavelength region of 400 nm to 700 nm in all cases.

1. A photocurable composition comprising:
(A) a fluorine-containing polymer having a cationically polymerizable group;
(B) a cationic photopolymerization initiator; and
(C) a cationically polymerizable compound.

2. The photocurable composition according to claim 1, wherein the cationically polymerizable group of the fluorine-containing polymer (A) having a cationically polymerizable group is at least one group selected from the group consisting of an epoxy group, an oxetanyl group, and a vinyloxy group.

3. The photocurable composition according to claim 1, wherein the cationically polymerizable group of the fluorine-containing polymer (A) having a cationically polymerizable group is an epoxy group and/or an oxetanyl group.

4. The photocurable composition according to claim 1, wherein the fluorine-containing polymer (A) having a cationically polymerizable group comprises at least a monomer unit having a cationically polymerizable group and a monomer unit represented by Formula (1) below 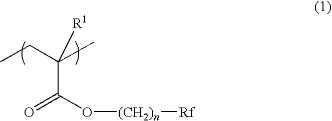
(in Formula (1), R¹ denotes a hydrogen atom or a methyl group, Rf denotes a fluoroalkyl group- or perfluoroalkyl group-containing group containing 4 or more fluorine atoms, and n denotes 1 or 2).

5. The photocurable composition according to claim 1, wherein the fluorine-containing polymer (A) having a cationically polymerizable group comprises, of the total monomer units, 1 to 60 mol % of a monomer unit represented by Formula (1).

6. The photocurable composition according to claim 1, wherein the fluorine-containing polymer (A) having a cationically polymerizable group has a weight-average molecular weight of at least 1,000 but no greater than 100,000.

7. The photocurable composition according to claim 1, wherein it has substantially no absorption in the visible region.

8. The photocurable composition according to claim 1, wherein the fluorine-containing polymer (A) having a cationically polymerizable group has a content of 0.001 to 40 wt % of the entire photocurable composition.

9. A process for producing an overprint, the process comprising:
a step of coating a printed material with a photocurable composition; and
a step of photocuring the photocurable composition to form an overprint layer;
the photocurable composition comprising (A) a fluorine-containing polymer having a cationically polymerizable group, (B) a cationic photopolymerization initiator, and (C) a cationically polymerizable compound.

10. The process for producing an overprint according to claim 9, wherein the cationically polymerizable group of the fluorine-containing polymer (A) having a cationically polymerizable group is at least one group selected from the group consisting of an epoxy group, an oxetanyl group, and a vinyloxy group.

11. The process for producing an overprint according to claim 9, wherein the cationically polymerizable group of the fluorine-containing polymer (A) having a cationically polymerizable group is an epoxy group and/or an oxetanyl group.

12. The process for producing an overprint according to claim 9, wherein the fluorine-containing polymer (A) having a cationically polymerizable group comprises at least a monomer unit having a cationically polymerizable group and a monomer unit represented by Formula (1) below 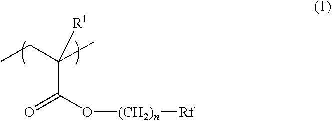
(in Formula (1), R¹ denotes a hydrogen atom or a methyl group, Rf denotes a fluoroalkyl group- or perfluoroalkyl group-containing group containing 4 or more fluorine atoms, and n denotes 1 or 2).

13. The process for producing an overprint according to claim 12, wherein the fluorine-containing polymer (A) having a cationically polymerizable group comprises, of the total monomer units, 1 to 60 mol % of a monomer unit represented by Formula (1).

14. The process for producing an overprint according to claim 9, wherein the fluorine-containing polymer (A) having a cationically polymerizable group has a content of 0.001 to 40 wt % of the entire photocurable composition.

15. The process for producing an overprint according to claim 9, wherein the printed material is an electrophotographically printed material.

16. The process for producing an overprint according to claim 9, wherein the printed material is an electrophotographically printed material having a fuser oil layer.

17. The process for producing an overprint according to claim 9, wherein the overprint layer has a thickness of at least 1 μm but no greater than 10 μm.

18. The process for producing an overprint according to claim 9, wherein the overprint layer is formed in an amount of 1 to 10 g/m².

19. The process for producing an overprint according to claim 9, wherein the overprint layer has substantially no absorption in the visible region.
